(19) United States
(12) Patent Application Publication
(10) Pub. No.: US 2007/0036438 A1
(43) Pub. Date: Feb. 15, 2007

(54) Methods and systems for identifying red eye pairs

(75) Inventor: Khagehwar Thakur, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(73) Assignee: Lexmark International, Inc.

(21) Appl. No.: 11/203,926

(22) Filed: Aug. 15, 2005

(51) Int. Cl. G06K 9/46; G06K 9/40

(52) U.S. Cl. 382/190; 382/275

(57) ABSTRACT

Identifying pairs of red eye candidates in a digital image includes determining at least one attribute associated with a first eye candidate, and at least one attribute associated with a second eye candidate. The at least one attribute associated with the first eye candidate is compared to the at least one attribute associated with the second eye candidate. Based on the comparison a score is assigned that is indicative of whether the first eye candidate and the second eye candidate form a matching pair of eyes.

### CROSS REFERENCES TO RELATED APPLICATIONS

This patent application is related to the U.S. patent application Ser. No. 10/883,121, filed on Jun. 30, 2004, entitled “Method and Apparatus for Effecting Automatic Red Eye Reduction” assigned to the assignee of the present application, the entire contents of which are incorporated by reference as if set forth fully herein.

### BACKGROUND

1. Field of the Invention

The present invention relates to methods and systems for image processing, and in particular, to methods and systems for processing an image having a red eye effect.

2. Description of the Related Art

Red eye effect is a common phenomenon in flash photography. Many methods have been proposed to reduce or remove the red eye effect in an image. For example, a user may be required to manually indicate a location of a red eye region. Thereafter, a computer is configured to find an extent of the red eye region, correct the extent, and color the extent of the red eye region with the rest of the image.

### SUMMARY OF THE INVENTION

The present invention is an automated red eye correction method. In some embodiments, the automated red eye correction method can find red eye effects in an image, and can correct the red eye effects without user intervention. For example, at a high level, the invention can use a search scheme that includes a plurality of steps. These steps can include the acts of finding skin tones of an image, finding candidate regions such as faces of the image based on the found skin tones, and finding red eye regions based on the candidate regions. Pairs of red eyes may be determined from candidate red eyes, where pairs are identified to confirm red eye regions. Red eyes may subsequently be automatically corrected.

According to one embodiment of the invention, there is disclosed a method of identifying a pair of eyes. The method includes identifying a first eye candidate and a second eye candidate in a digital image, and determining at least one attribute associated with the first eye candidate, and at least one attribute associated with the second eye candidate. The method further includes comparing the at least one attribute associated with the first eye candidate to the at least one attribute associated with the second eye candidate to determine whether the first eye candidate and the second eye candidate form a matching pair of eyes.

According to an aspect of the invention, the at least one attribute associated with the first eye is the number of substantially red eye pixels of the first eye, and the at least one attribute associated with the second eye is the number of substantially red eye pixels of the second eye. According to another aspect of the invention, the at least one attribute associated with the first eye can be a measure of the size of the first eye, and the at least one attribute associated with the second eye can be a measure of the size of the second eye. According to yet another aspect of the invention, the at least one attribute associated with the first eye is the number of substantially white pixels of the first eye, and the at least one attribute associated with the second eye is the number of substantially white pixels of the second eye.

The method may also include determining the orientation of the first eye based on the location of white pixels in a region surrounding the first eye and determining the orientation of the second eye based on the location of white pixels in a region surrounding the second eye. Furthermore, the at least one attribute associated with the first eye may be the orientation of the first eye, and the at least one attribute associated with the second eye may be the orientation of the second eye. According to another aspect of the invention, the method may include ranking the first eye candidate and the second eye candidate in a plurality of eye-pairs based on the score. According to yet another aspect of the invention, the method may include assigning a score, based on the comparison of the at least one attribute associated with the first eye candidate and the at least one attribute associated with the second eye candidate, and the score may be used to determine whether the first eye candidate and the second eye candidate form a matching pair of eyes.

According to another embodiment of the invention, there is disclosed a method of identifying a pair of eyes. The method includes identifying a first eye candidate and a second eye candidate in a digital image, determining the size of the first eye candidate, and determining the distance between the first eye candidate and the second eye candidate. The method further includes calculating a ratio based on the distance and the size of the first candidate, and assigning a score, based on the calculation of the ratio, where the score is indicative of whether the first eye candidate and the second eye candidate form a matching pair of eyes.

According to an aspect of the invention, the size of the first eye candidate is the radius, or approximately the radius, of the iris of the first eye candidate. According to another aspect of the invention, the size of the first eye candidate is the circumference, or approximately the circumference, of the iris of the first eye candidate. According to yet another aspect of the invention, the size of the first eye candidate is the radius, or approximately the radius, of the iris of the first eye candidate.

According to another aspect of the invention, determining the size of the first eye candidate includes determining the size of the first eye candidate based on a measure of the amount of substantially red pixels in the first eye candidate. Determining the distance between the first eye candidate and the second eye candidate may also include determining the distance between substantially the center of the first eye candidate and substantially the center of the second eye candidate. The method may also include ranking the first eye candidate and the second eye candidate in a plurality of eye-pairs based on the score.

According to another embodiment of the invention, there is disclosed a method of identifying a pair of eyes. The method includes identifying a first eye candidate and a second eye candidate in a digital image, determining an average eye size of the first eye candidate and the second eye candidate, and determining the distance between the first eye candidate and the second eye candidate. The method also includes calculating a ratio based on the distance and the average eye size, and identifying, based on the calculated ratio, that the first eye candidate and the second eye candidate form a matching pair of eyes.

According to another embodiment of the invention, there is disclosed a method of identifying a pair of eyes. The method includes identifying a plurality of eye candidates in a digital image, determining an attribute associated with each one of the plurality of eye candidates, and comparing the attribute of a first eye candidate of the plurality of eye candidates to the attribute of each other eye candidate of the plurality of eye candidates. The method further includes assigning respective scores, based on the comparison, of the first eye candidate and each of the other eye candidates of the plurality of eye candidates, and identifying at least one matching pair of eyes based on the respective scores.

According to one aspect of the invention, determining an attribute includes measuring the number of substantially white or substantially red pixels associated with each one of the plurality of eye candidates. According to another aspect of the invention, determining an attribute includes determining the orientation of each one of the plurality of eye candidates. According to yet another aspect of the invention, determining an attribute includes determining the size of each one of the plurality of eye candidates. Additionally, comparing the attribute may include determining the distance between the first eye candidate and each other eye candidate, and determining an attribute may include determining the ratio of substantially white pixels to substantially red pixels in each one of the plurality of eye candidates.

Other features and advantages of the invention will become apparent to those skilled in the art upon review of the following detailed description, claims, and drawings.

### BRIEF DESCRIPTION OF THE DRAWINGS

The patent or application file contains at least one drawing executed in color. Copies of the patent or patent application publication with color drawings(s) will be provided by the Office upon request and payment of the necessary fee.

FIG. 1 shows an overview flow chart of an embodiment of the invention.

FIG. 2 shows a skin tone detection flow chart according to an embodiment of the invention.

FIG. 3 shows a second skin tone detection scheme according to an embodiment of the invention.

FIG. 3A shows an exemplary image including two faces and having red eye effects.

FIG. 3B shows a plurality of skin tone pixels detected by the skin tone detection scheme from the image of FIG. 3A.

FIG. 3C shows a plurality of detected connected regions represented by different shading colors.

FIG. 3D shows a plurality of solidified regions of the connected groups in FIG. 3C.

FIG. 3E shows a plurality of face boxes for the solidified regions of FIG. 3D.

FIG. 3F shows an exemplary distance map obtained from the face boxes.

FIG. 3G shows an exemplary equalized distance map obtained from the distance map.

FIG. 3H shows an exemplary distance map obtained from the equalized distance map after thresholding.

FIG. 3I shows a plurality of red eye pixels determined in the face boxes.

FIG. 3J shows a plurality of opened red eye pixels after two iterations of erosion and dilation.

FIG. 3K shows a floating-point contrast map during the first iteration of a red eye mapping scheme.

FIG. 3L shows a normalized contrast map during a first iteration of the red eye mapping scheme.

FIG. 3M shows a normalized contrast map during a second iteration of the red eye mapping scheme.

FIG. 3N shows a normalized contrast map during a fifth iteration of the red eye mapping scheme.

FIG. 3O shows a finished image with the red eye effect removed from the original image of FIG. 3A.

FIG. 4 shows a flow chart of a shape identification scheme according to an embodiment of the invention.

FIG. 5 shows a red eye mapping scheme according to an embodiment of the invention.

FIG. 6A shows an illustrative example of two eyes that make up a matching pair of eyes.

FIG. 6B shows an illustrative example of two eyes that make up a non-matching pair of eyes.

FIG. 7 shows an illustrative example of two eyes that make up a non-matching pair of eyes.

FIG. 8A shows an illustrative example of two eyes positioned substantially along a horizontal ‘x’ axis.

FIG. 8B shows an illustrative example of two eyes positioned substantially along a vertical ‘y’ axis.

FIG. 8C shows an illustrative example of two eyes positioned along a line disposed at approximately 45 degrees from a vertical ‘y’ axis and a horizontal ‘x’ axis.

FIG. 9A shows an illustrative non-matching pair of eyes located near each other.

FIG. 9B shows an illustrative matching pair of eyes.

FIG. 9C shows an illustrative non-matching pair of eyes located far from each other.

FIG. 10 shows a flow chart of a red eye pair identification process according to an embodiment of the invention.

FIG. 11 shows a flow-chart of a red eye reduction process according to an embodiment of the invention.

FIG. 12 shows a red eye reduction system according to an embodiment of the invention.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including, ” “comprising, ” or “having ” and variations thereof herein is meant to encompass the items listed thereafter and equivalents thereof as well as additional items. Unless limited otherwise, the terms “connected, ” “coupled, ” and “mounted ” and variations thereof herein are used broadly and encompass direct and indirect connections, couplings, and mountings. In addition, the terms “connected ” and “coupled ” and variations thereof are not restricted to physical or mechanical connections or couplings.

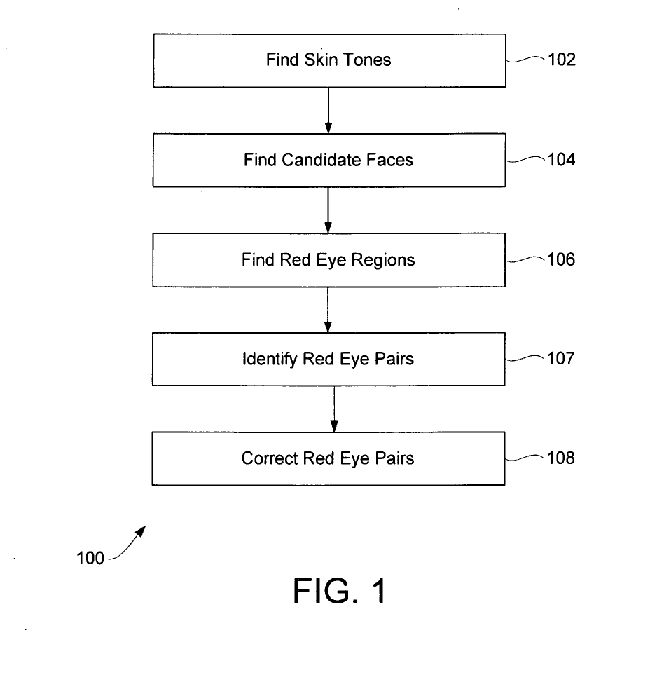

FIG. 1 shows an overview flow chart of a method 100 according to an embodiment of the invention. At block 102, the method 100 finds pixels that have characteristics of skin tones. After pixels that have characteristics of skin tones have been detected, the method 100 finds candidate faces from the detected pixels at block 104. Thereafter, the method 100 proceeds to find candidate red eye regions from the candidate faces at block 106. As shown at block 107, using candidate red eye regions, the method compares the features of each candidate red eye to other candidate red eye regions to identify matching pairs of eyes. The method then corrects the matching pairs of red eyes at block 108. Details of these blocks are discussed hereinafter.

Some embodiments of the present invention use a database of skin tones. After an image has been acquired, each of the pixel data of the image is compared to the data stored in the skin tone database. When there is a match between the pixel data and the data stored in the skin tone database, or that the pixel data falls within a skin tone boundary set by the skin tone database, the pixel data is classified or identified as skin tone pixel data.

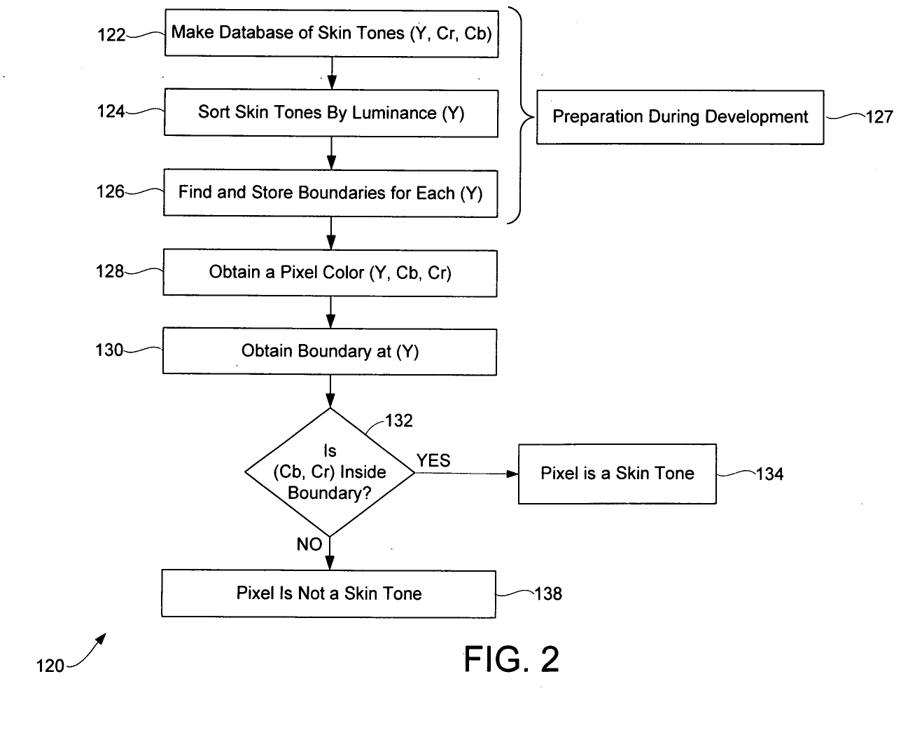

FIG. 2 shows a flow chart of a skin tone detection scheme 120 according to an embodiment of the invention. At block 122, a skin tone database is constructed. Specifically, to construct the skin tone database in some embodiments, known skin tone pixels from a plurality of images are collected or handpicked. The images can be representative of a vast number of people, races, and skin colors or subset thereof. The skin tone database can also or instead be constructed by selecting any number of ranges of colors to be identified as skin tones.

Skin tones collected from the images (or in any other manner) can be sorted by image attribute or color space (e.g., sorted by luminance, Y, as shown in the illustrated embodiment at block 124). As a result, the sorted skin tone based on color space provides a plurality of efficient lookup tables. Although luminance of a Y-Cb-Cr color space is used in the embodiment of FIG. 2, any other color spaces such as RGB, Lab, HSV, and the like can be used as desired. Specifically, a (Cb, Cr) pair set corresponding to each Y value can be stored in a table or other form indexed by Y value. For each Y value, all (Cb, Cr) pair sets can be plotted. A (Cb, Cr) pair boundary for each Y value can thereafter be developed. The vertices of the boundary for each Y value can thus be stored in a table (or in any other format) of the skin tone database at block 126. As indicated at 127, the processes described in blocks 122, 124 and 126 are typically performed during development activities with the results stored for use in either software or firmware installed in processing device.

To find or search whether a pixel is skin color, the skin tone detection scheme 120 of the illustrated embodiment can initially convert the pixel color to a Y-Cb-Cr color space equivalent at block 128. The skin tone detection scheme 120 may then extract the Y index of the pixel of the image, and compare it to the Y indices of the skin tone database. When there is a match between the extracted Y index and a Y index of the skin tone database, the skin tone detection scheme 120 can compare the extracted (Cb, Cr) pair with the corresponding (Cb, Cr) pair set in the database at block 130. More particularly, the skin tone detection scheme 120 can check to determine if the extracted (Cb, Cr) pair falls within the (Cb, Cr) pair boundary set of the Y index at block 132. If the (Cb, Cr) pair is inside the (Cb, Cr) pair boundary set, the pixel is considered or labeled as a skin tone pixel at block 134. Otherwise, the pixel is considered or labeled as a non-skin tone pixel at block 138.

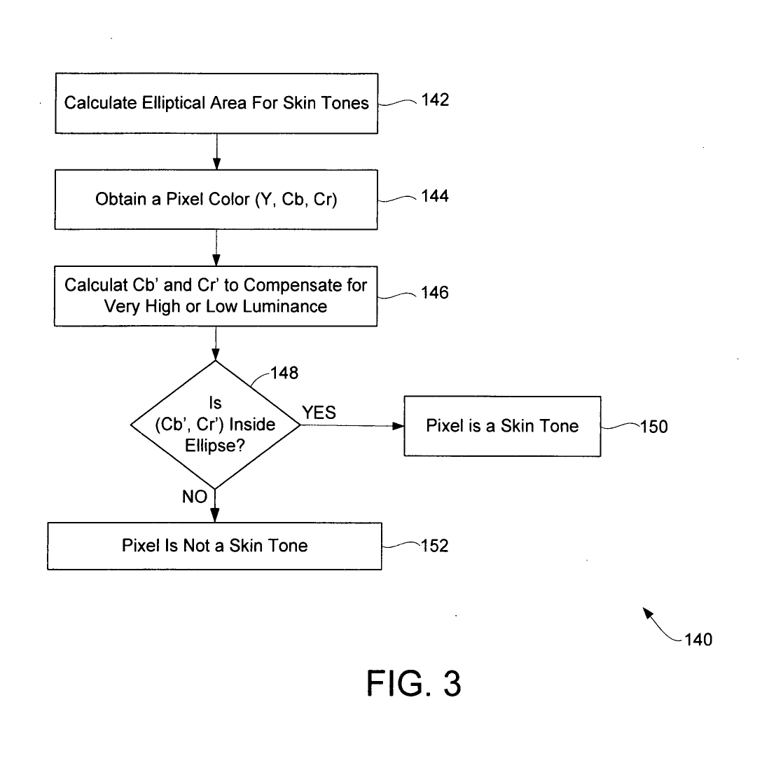

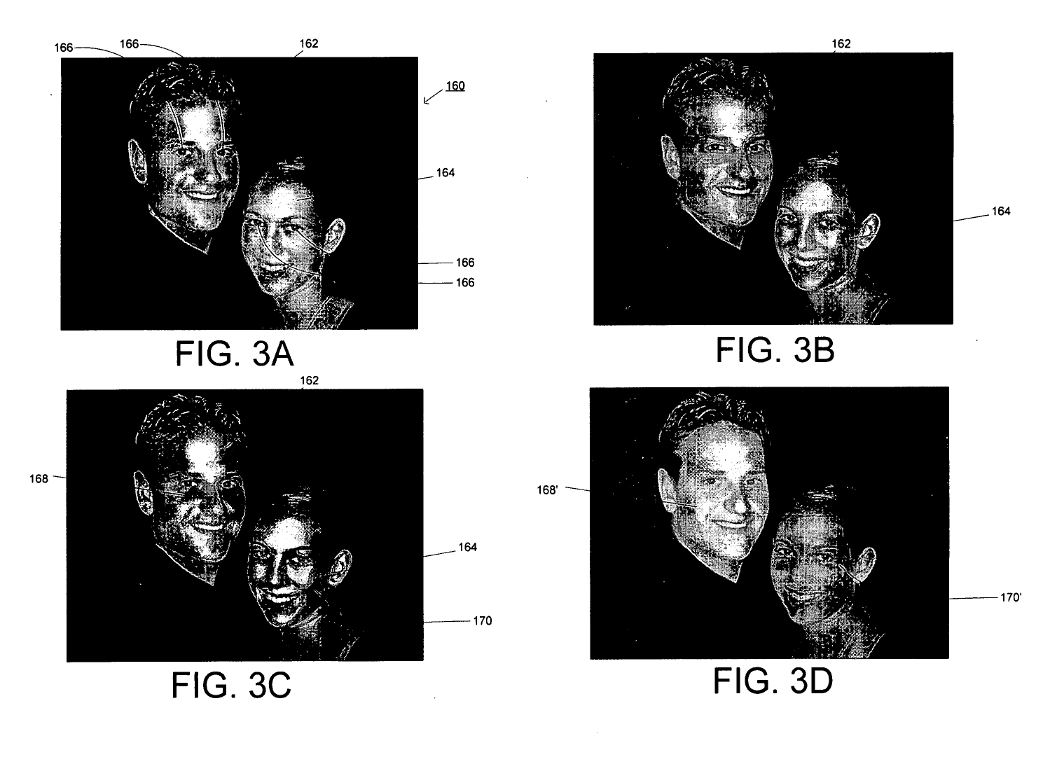

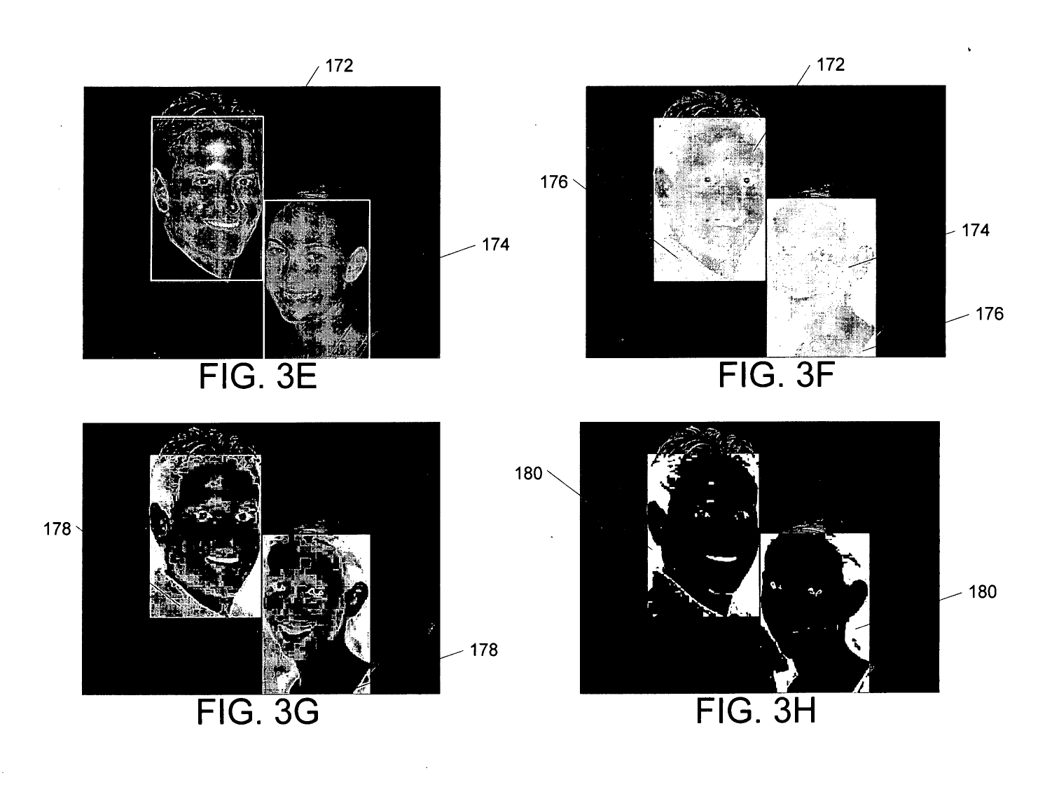

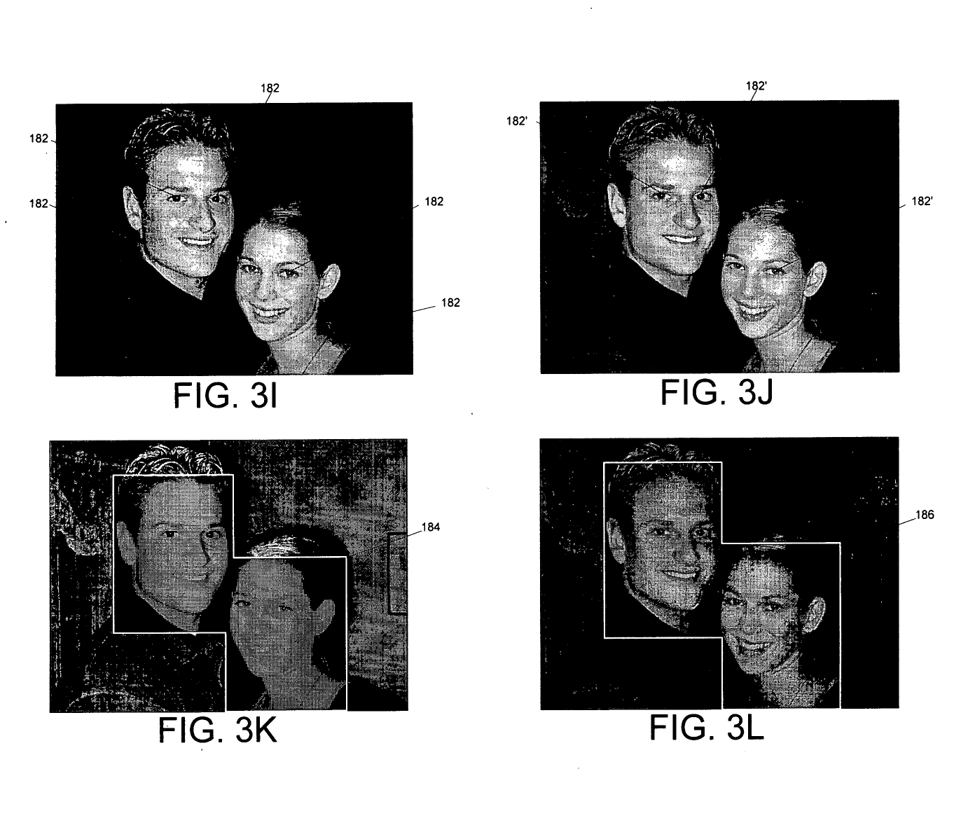

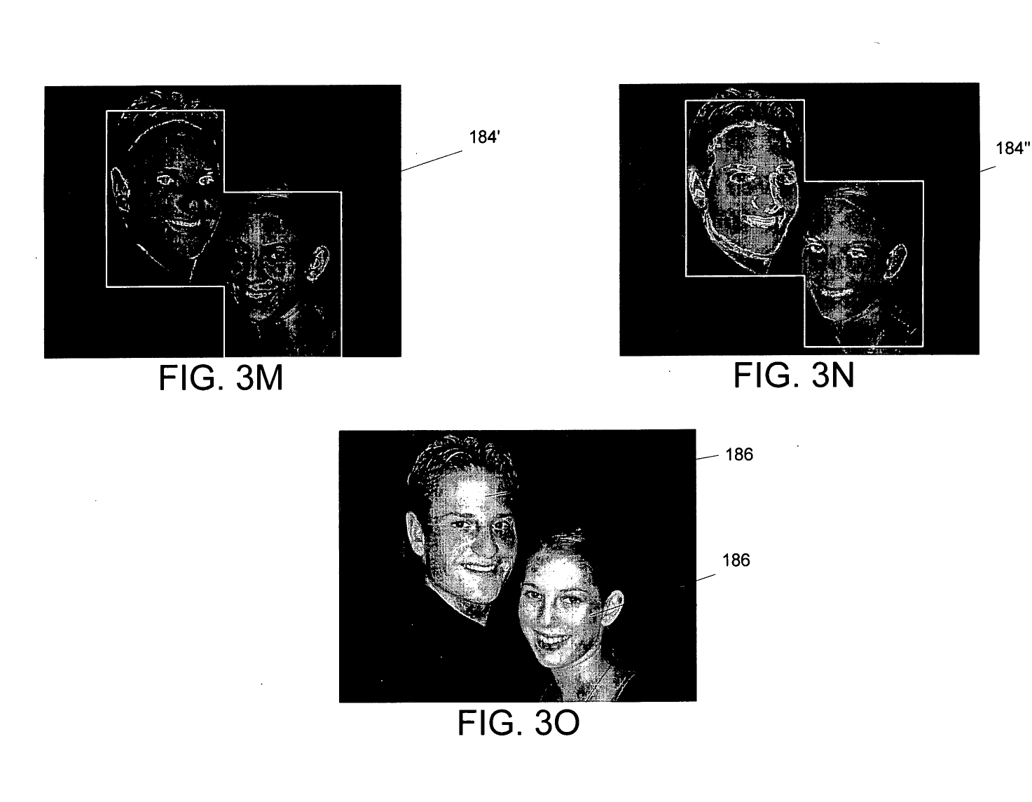

Other techniques of determining whether an image pixel is a skin tone pixel can also be used. For example, in another embodiment as shown in FIG. 3, a second skin tone detection scheme 140 initially assumes that an ellipse represents all skin tones. Specifically, the skin tone detection scheme 140 illustrated in FIG. 3 calculates an elliptical area for skin tones at block 142, similar to the boundary established in FIG. 2. That is, the elliptical area will therefore represent all skin tones for all luminance values. In this way, determining if a point is inside the ellipse consumes less time than determining if the same point is inside a boundary as discussed earlier, and shown in FIG. 2. However, since one elliptical area is used for all luminance values, the (Cb, Cr) pairs of the elliptical area are generally compensated for low and high luminance values. Specifically, the second skin tone detection scheme 140 can obtain pixel attributes such as color of the pixel, using a Y-Cb-Cr color space at block 144. Depending on the luminance obtained, the (Cb, Cr) pair is compensated for luminance at block 146 to obtain a (Cb′, Cr′) pair. In this way, a bias due to lighting color can be eliminated, thereby enabling normalization of colors so that such colors can be shown or determined without such bias. Thereafter, the second skin tone detection scheme 140 of FIG. 3 determines if the transformed (Cb′, Cr′) pair is in the generated ellipse at block 148. If the (Cb′, Cr′) pair is inside the ellipse set, the pixel is considered or labeled as a skin tone pixel at block 150. Otherwise, the pixel is considered or labeled as a non-skin tone pixel at block 152. For a relatively high-resolution image, in some embodiments only portions of all the skin pixels are located. Therefore, some pixels can be bypassed or skipped depending on the resolution of the image. For example, in some embodiments every other pixel can be bypassed for a 100-200 dpi image. As another example, in some embodiments every third pixel can be located for a 200-300 dpi image. FIG. 3A shows an image 160 having two faces 162, 164. Each of the faces 162, 164 has a pair of eyes 166 reacting to a flash and thus exhibiting red eye effects. FIG. 3B shows a plurality of skin tone pixels of the faces 162, 164 (highlighted in magenta) detected by the skin tone detection scheme 140 from the image 160 of FIG. 3A.

Once the skin tone pixels have been detected, such as by using one of the skin tone detection schemes 120, 140 described above, some of the embodiments of the red eye reduction method according to the present invention determine a shape of the identified image data having characteristics of the skin pixels, as described at block 104 of FIG. 1. Exemplary determined shapes can include hands, faces, feet, necks, and the like, some of which (i.e., face shapes) include eyes.

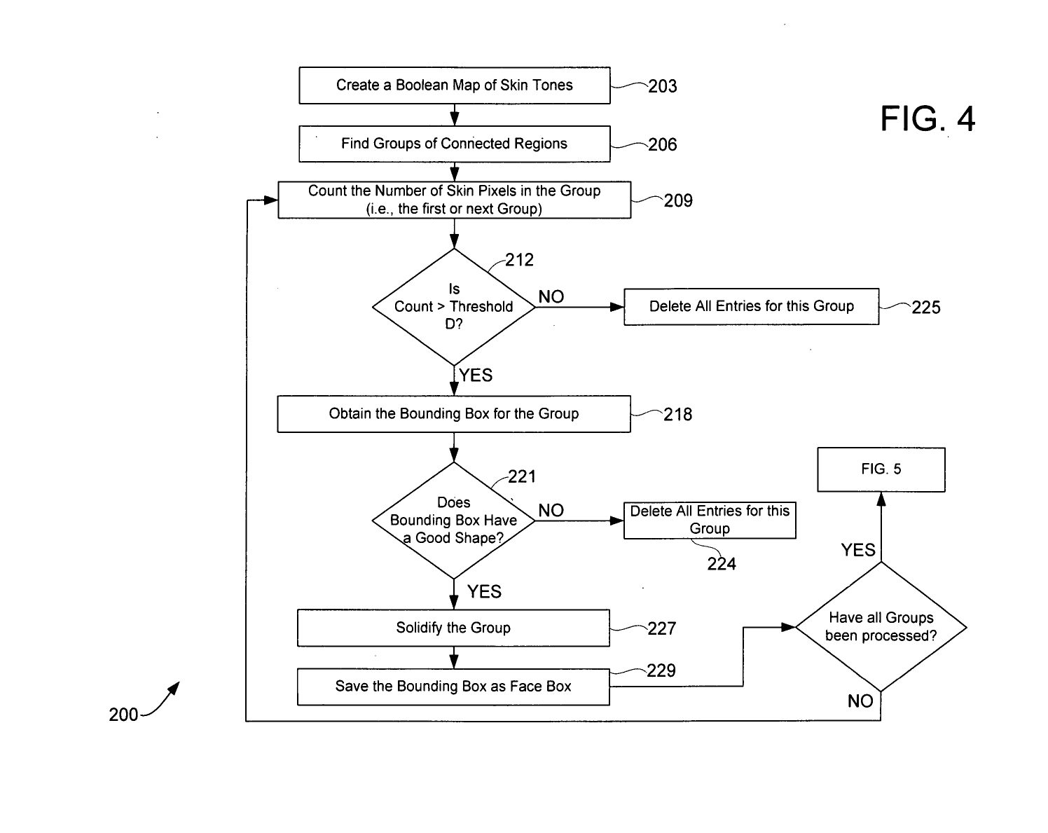

FIG. 4 shows a flow chart of a shape identification scheme 200 according to an embodiment of the invention. Skin tone pixels of an image (e.g., those detected in the previous detection scheme or otherwise identified in any other manner) can be stored in a buffer at block 203. In some embodiments, the storing buffer can be a Boolean buffer that has the same size as the original image. Each entry in the Boolean buffer may have a true/false value indicating whether the corresponding pixel in the image is a skin tone pixel. Due to noise, image defects (e.g., photo overexposure), or other causes, incorrectly identified pixels are possible. To filter out incorrect skin pixel determinations, the method in the embodiment of FIG. 4 can isolate groups or regions of connected pixels determined to be skin tone pixels, such as groups of 4 or 8-connected pixels at block 206. FIG. 3C shows a plurality of detected connected regions 168, 170 represented by different shading colors obtained at block 206. The number of connected skin tone pixels in each connected skin tone pixel group is counted at block 209. At block 212 the count is compared with an empirically determined threshold. If the number falls below the threshold at block 212, the entire connected group can be considered spurious and thus be deleted from the buffer at block 225. Otherwise, the group of connected pixels is further analyzed.

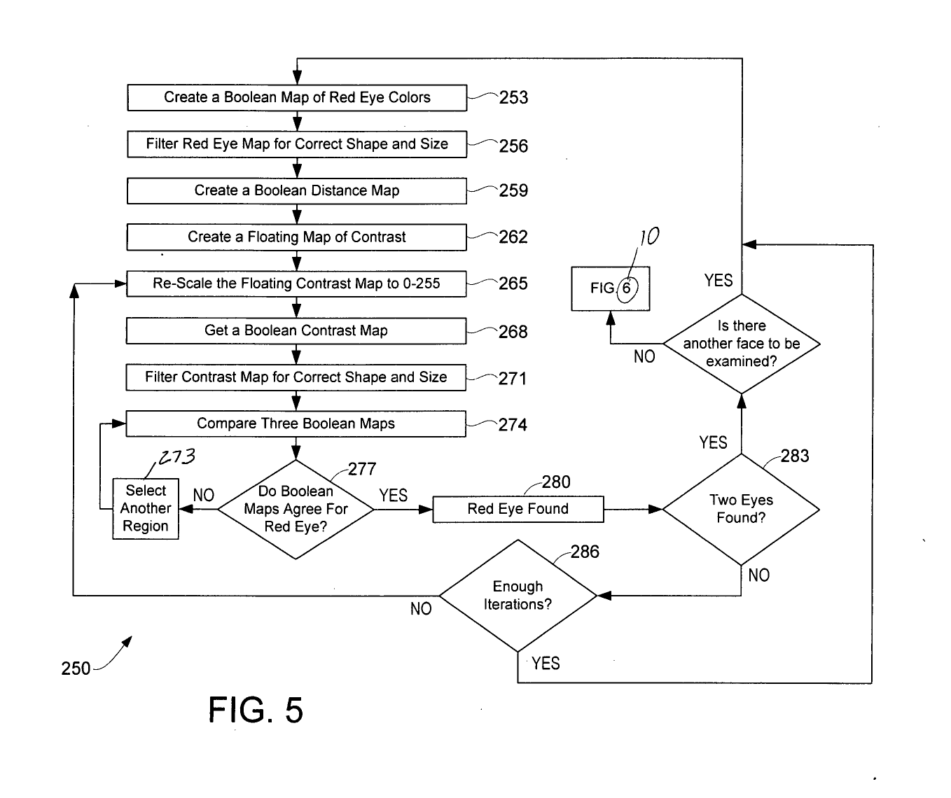

In some embodiments, once the connected group of skin tone pixels has a minimum number of connected skin tone pixels to exceed the threshold, a bounding box of the connected group is obtained at block 218 to include all the connected groups. Each bounding box has a shape. Therefore, the bounding boxes will have many different shapes. However, a typical face will have a bounding box that is mostly rectangular in shape with its height being about twice its width, or is a square. The shape of the bounding box is examined at block 221. Particularly, a badly shaped bounding box is considered as non-candidate groups and is deleted from the storing buffer at block 224. For example, a bounding box with its width being four times its height is considered unlikely to contain a face, and therefore, the bounding box is considered a badly shaped bounding box. As a result, the pixels in the bounding box are eliminated from further analysis. Otherwise, the bounding box of connected groups can be considered to have an acceptable shape, and therefore merits further analysis. As a result, the bounding boxes of the remaining connected groups or regions of skin tone pixels can be passed on as candidate shapes or faces, or simply face boxes. There can be many face boxes in an image. For each face box, the gaps left by incorrect skin pixel determinations or enclosed by connected groups are filled or solidified as skin tone pixels at block 227. FIG. 3D shows a plurality of solidified regions 168′, 170′ (in yellow and magenta, respectively) of the connected groups obtained at block 227 for the image 160. At block 229, the bounding box is saved as a face box. FIG. 3E shows a plurality of face boxes 172, 174 obtained at block 229 for the solidified regions 168′, 170′ of the image 160. At block 231, the process continues until all the groups have been examined. After all of the groups have been processed, a red-eye mapping scheme as exemplified in FIG. 5 is used as indicated at 233. It should be realized that once a face box has been determined, that that face box could be examined with the red-eye mapping scheme while identification of other face boxes continues. In some embodiments, the shape identification scheme 200 can develop a rectangular face box that encompasses an entire face. Thereafter, pixels inside the rectangular face identified as skin tone pixels can be filled or solidified.

Optionally, in some embodiments, the shape identification scheme 200 can find a plurality of edges in an image and can store the edge pixels as non-skin pixels in the buffer. These edges can be identified after a skin tone pixel detection process (such as those described above), or after finding connected skin tone pixel groups (as also described above). In this way, different body parts can be separated. For example, in some cases, face pixels and shoulder pixels will appear connected since they can have the same color. However, marking the edge pixels of chin as non-skin pixels can open up a gap between a face and a shoulder in an image. As a result, the shape identification scheme 200 will have a smaller or reduced number of search areas to examine. Edge detection can be performed by any number of standard algorithms, such as by using a Canny edge detector or Shen-Castan edge detector. If desired, pixels can be skipped or bypassed in this step, such as for high-resolution images as described earlier.

A red eye mapping scheme 250 according to an embodiment of the present invention is shown in FIG. 5, and can be used to map different pixel attributes to determine or find a red eye region. This process can be used in conjunction with the shape identification scheme 200 described above, such as after a candidate shape has been determined in some embodiments. For executing this scheme, it is assumed that an eye has a white portion on at least one side of an iris circle, that the eye has at least a few red eye pixels, and/or that the eye has a relatively higher contrast when compared to skin tone pixels. In the embodiment of FIG. 5, three types of attribute maps are used in determining if at least one red eye is present in an image. However, any other number of maps can also be used to determine the presence of a red eye.

In some embodiments, the red eye mapping scheme 250 first creates, for all face boxes, a Boolean map of red eye colors in the image at block 253. To use the red eye map, a red eye database can be made for red eye colors. Similar to the manner of skin tone detection described above with reference to FIG. 2, a red eye database can be constructed from known red eye pixels from a plurality of images collected or handpicked, or by selecting such colors in any other manner and is stored for use by the process as previously described for the skin tones database. Images can be representative of a number of people, races, and skin colors or any subject thereof.

Red eyes collected from the images can be sorted by image attribute or color space (e.g., sorted by luminance). As a result, the sorted red eyes based on color space can provide a plurality of efficient lookup tables. Although luminance of a Y-Cb-Cr color space is used in the embodiment of FIG. 5, any other color spaces such as RGB, Lab, HSV, and the like can be used as desired. Specifically, a (Cb, Cr) pair set corresponding to each Y value can be stored in a table or other form indexed by Y value. For each Y value, all (Cb, Cr) pair sets can be plotted. A (Cb, Cr) pair boundary for each Y value can thereafter be developed. The vertices of the boundary for each Y value can thus be stored in a table (or in any other format) of the red eye database.

To find or search whether a pixel is red eye pixel, the method illustrated in FIG. 5 can initially convert the pixel color to a Y-Cb-Cr color space equivalent. The red eye mapping scheme 250 can then extract the Y index of the pixel of the image, and compare it to the Y indices of the red eye database. When there is a match between the extracted Y index and a Y index of the red eye database, the red eye mapping 250 scheme can compare the extracted (Cb, Cr) pair with the corresponding (Cb, Cr) pair set in the database. More particularly, the red eye mapping scheme 250 can check to determine if the extracted (Cb, Cr) pair falls within the (Cb, Cr) pair boundary set of the Y index. If the (Cb, Cr) pair is inside the (Cb, Cr) pair boundary set, the pixel is considered a red eye pixel. Thereafter, the red eye mapping scheme 250 can filter the red eye map for a right shape and a right size at block 256, in a manner similar to deleting the badly shaped bounding boxes at block 221 as discussed earlier. For example, if a rectangular shaped red eye region is unlikely to contain a red eye, it may be considered a non-red eye candidate. The remaining red eye regions are then considered red eye candidates. The non-red eye candidates are then deleted, whereas the red eye candidates are kept for further analysis.

In some embodiments, the red eye mapping scheme 250 uses a distance map to locate or to find at least one white eye portion in an image (e.g., in a candidate face box described above). For example, the red eye mapping scheme 250 in the embodiment of FIG. 5 can create a Boolean distance map at block 259. FIG. 3F shows an exemplary distance map 176 obtained from the face boxes 172, 174. Specifically, the red eye mapping scheme 250 can store a distance from a neutral color for each pixel. If a pixel has a high luminance value or has a color space distance relatively distant from the neutral color, the pixel can be generally considered white. A distance can be determined by calculating a standard deviation between red, green and blue components of the pixel. In many cases, distances thus found remain in a relatively narrow band and can be difficult to distinguish from one another. Therefore, in some embodiments the red eye mapping scheme 250 applies histogram equalization on the distance map in a manner known in the art. Equalized distances can then be compared with a predetermined high threshold value, to create a Boolean map carrying true/false values. For example, any pixel having an equalized distance above 200 can be considered white and made true in the distance map, while others can be labeled false. FIG. 3G shows an exemplary equalized distance map 178 obtained from the distance map 176. Comparing the luminance values of the pixels can further reduce the number of pixels in the distance map to be analyzed. For example, if the luminance of a pixel is less than a threshold of 200, the pixel can be considered a non-white color, and the corresponding entry from the distance map can be deleted. FIG. 3H shows an exemplary distance map 180 obtained from the equalized distance map 176 after thresholding at block 259.

In operation, the red eye mapping scheme 250 can determine whether a pixel is a red eye pixel for each pixel in a set of pixels (e.g., in the face box as described above). The true/false results can be stored in a red eye map that generally has the same size as the face box. FIG. 3I shows a plurality of red eye pixels 182 determined in the face boxes 180. A few passes of erosion followed by dilation can be performed on the red eye map. The image processing technique of erosion followed by dilation is known as opening and creates or opens up a plurality of small gaps between connected groups or regions. Connected regions can thus be located, and thereafter a decision can be made regarding whether the pixels therein belong to a red eye. The red eye mapping can be based at least in part on the number of pixels in the region or group, and the shape of the bounding box (if used). Unlikely candidates can be deleted from the red eye map. FIG. 3J shows a plurality of opened red eye pixels 182′ after two passes or iterations of erosion and dilation.

Some embodiments of the present invention use a contrast map to determine the contrast in the pixels being examined. This contrast map (created at block 262 in the embodiment of FIG. 5) can again use gray scale dilation and erosion to construct a contrast map of a candidate face or facial area with floating-point values. Since contrast map values can vary from face to face, the contrast map can be scaled or normalized. For example, in the embodiment of FIG. 5, the contrast map is re-scaled or normalized to between 0 and 255 for each face at block 265. It is also contemplated that pixels can be bypassed or skipped if needed. FIG. 3K shows a floating-point contrast map 184 during the first iteration of the red eye mapping scheme 250. Similarly, FIGS. 3L, 3M, and 3N show a plurality of normalized contrast maps 184, 184′, 184″ during a first, a second, and a fifth iteration of the red eye mapping scheme 250, respectively.

In general, the decision regarding whether a red eye has been detected by the red eye mapping scheme 250 can require several passes or iterations of the red eye mapping scheme 250. For example, in the embodiment of FIG. 5, the red eye mapping scheme 250 starts with making a Boolean contrast map from the contrast map with floating-point values at block 268, and filters the contrast map for a right shape and a right size at block 271 in a similar manner as described earlier. More specifically, if a floating-point contrast value is more than a threshold value, the corresponding entry in the Boolean contrast map can be labeled true. Otherwise, the entry in the Boolean contrast map is labeled false. Depending on the resolution of the image, some pixels can be bypassed to enhance the speeds of the mapping scheme 250.

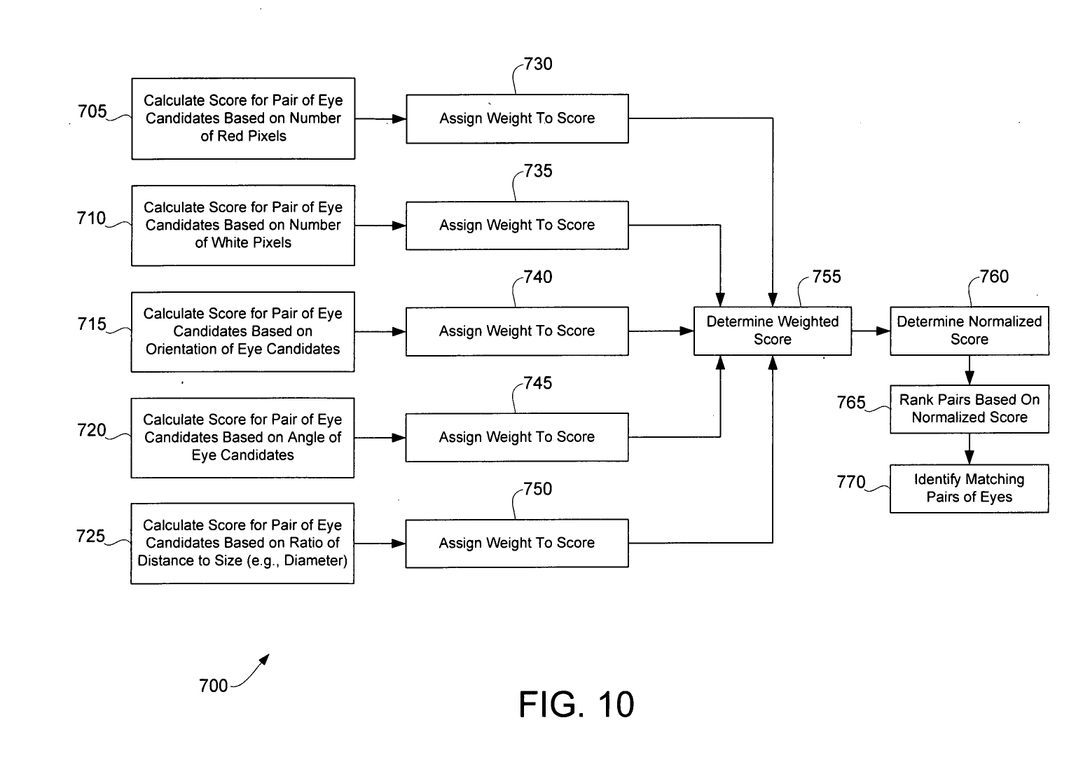

In some embodiments, connected regions in the Boolean contrast map of the red eye mapping scheme 250 are located. Based at least in part on the shape and size of the regions, the mapping scheme 250 can determine whether the region is a viable red eye candidate at block 274. Unlikely candidates can be deleted. For each candidate region, the mapping scheme 250 references the red eye map, the distance map, and the contrast map. If all three maps agree on the candidacy at block 277, the region can be considered red eye at block 280. If less than all three maps agree on the candidacy at 277, another region is then examined at block 275, and therefore, block 274 is repeated. In other embodiments, less than all maps need to agree for a determination that a red eye has been found. After the red eye mapping scheme 250 determines that a red eye has found at block 280, and if the mapping scheme 250 identifies two eyes for a face at block 283, at block 285 the mapping scheme 250 determines if other faces are to be examined starting again at block 253. If no other faces are to be examined, the process continues with identification of the two eyes as being a pair of eye as illustrated in FIG. 10 and as indicated at block 287. Otherwise, if less than two eyes are found, the mapping scheme 250 can re-scale the floating-point contrast map so that the mid point contrast of 127 now maps to end point contrast 255 at block 265 if a pre-determined number of iterations has not yet been performed as determined at block 286. If the pre-determined number of iterations has been performed as determined at block 286, it is determined at block 285 if another face box of the image is to examined. After a predefined number of iterations, the process can stop even if the red eye mapping scheme 250 does not find a red eye.

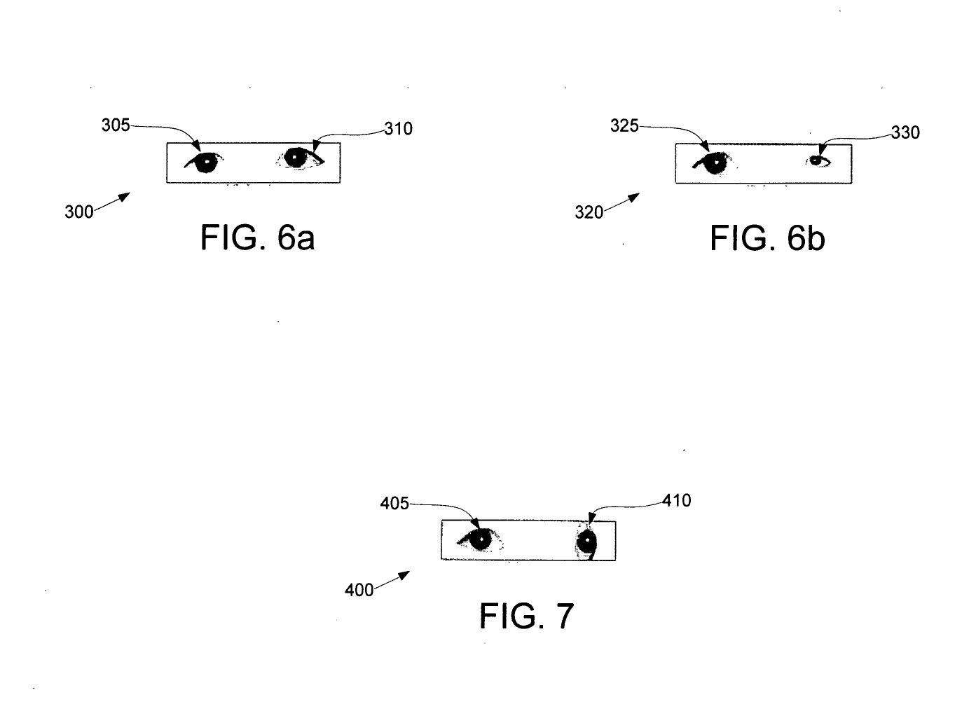

According to an embodiment of the invention, a pair of red eyes must be identified before a red eye is corrected, as is shown in block 107 of FIG. 1. This process may be used to improve the success rate by which red eyes are automatically identified. The identification of a pair of eyes may be implemented at block 283 of FIG. 5 and/or may be performed just prior to red eye correction, which is described in detail below. Generally, to effect the identification of a pair of eyes out of all eye candidates identified by the process described above, features of each possible pair of eyes are compared. A score is then assigned to each pair based on the degree of their match. For instance, if a first eye candidate and second eye candidate are of similar size as shown in FIG. 6a, they may receive a good score that is indicative of a matching pair of eyes. In contrast, if a first eye candidate and a second eye candidate are very different in size as illustrated in FIG. 6b, then the pair will receive a very low score that is indicative that the pair is an unlikely pair.

According to one aspect of the invention, comparisons are made between eye candidate based on a number of different features and/or attributes. For instance, eye candidates may be compared based on their respective sizes, orientations, the number of substantially white pixels in the eye candidate, and/or the number of substantially red pixels in the eye candidate. The distance between pairs of eye candidates, the ratio of their distance to the diameter of one eye in the pair, and/or the orientation (or angle) of pairs of eye candidates may also be used to determine a score for a pair of eye candidates. It will be appreciated that multiple comparisons and determinations may be made on a given pair of eye candidates to generate scores for the pair of eye candidates. Therefore, the scores may be combined into a single score, which may represent a weighted score that provides higher significance to one of the comparisons or determinations. For instance, because the respective size of two compared eye candidates may be deemed more important than the number of red pixels the respective compared eye candidates, the former comparison may be considered more relevant in generating a weighted score for the pair of eyes, and thus may be weighted, e.g., as twice as relevant in determining the weighted score.

Next, FIG. 6A shows an illustrative example of two eyes 305, 310 that make up a likely matching pair of eyes 300. In contrast, FIG. 6B shows an illustrative example of two eyes 325, 330 that make up a likely non-matching pair of eyes 320. According to an aspect of the invention, once red eye candidates are identified using the process described in detail above, the number of red eye pixels, or substantially red pixels, in each candidate eye may be calculated, which provides an estimate of the eye size. Thus, because the eyes 305, 310 illustrated in FIG. 6A have a similar number of red pixels, the pair 300 may receive a relatively high score indicative of a matching pair of eyes. On the other hand, because the eyes 325, 330 illustrated in FIG. 6B have a dissimilar number of red pixels, the pair 320 may receive a relatively low score indicative of a non-matching pair of eyes. It will also be appreciated that in addition to the number of red pixels, another attribute, the number of white pixels, may also be used to determine the size of respective candidate eyes. White pixels, or substantially white pixels, typically represent the sclera of the eye, although they may also represent non-eye features such as teeth or glare. The number of white pixels surrounding an eye candidate provides an estimate of the eye size. As with the red pixel comparison, comparing the number of white pixels in two eye candidates may help identify a pair of matching eyes. A similar number of white pixels in respective eye candidates will represent a high likelihood that the eye candidates are a matching pair of candidate eyes. In contrast, a significantly different number of white pixels in respective eye candidates will represent a low likelihood that the eye candidates are a matching pair of candidate eyes.

FIG. 7 shows an illustrative example of two eyes 405, 410 that make up a non-matching pair of eyes 400. According to an aspect of the invention, the orientation of each eye may be identified and then compared against other eye candidates. Pairs of eye candidates having different orientations may receive a low score indicative of a low likelihood that the eye candidates for a pair, whereas a pair of eye candidates having the same orientation may receive a high score indicative of a high likelihood that the pair forms a matching pair. To determine the orientation of each eye candidate for comparison, the present invention may determine the location of white pixels relative to the red eye. For instance, in a horizontal eye, such as eye 405 of FIG. 7, most of the sclera (and hence, white pixels) is positioned to the left or right of the iris. For a vertical eye, such as eye 410 in FIG. 7, most of the sclera (and hence, white pixels) is positioned above or below the iris. Therefore, the orientation of each eye may be determined by counting the number of white pixels, or the number of substantially white pixels, in the four quadrants of the eye (where the four quadrants are formed by two lines at right angles from each other, which intersect at the center of the eye). FIG. 7 shows a non-matching pair of eyes 400 having different orientations. As a result, the non-matching pair of eyes 400 will receive a low score.

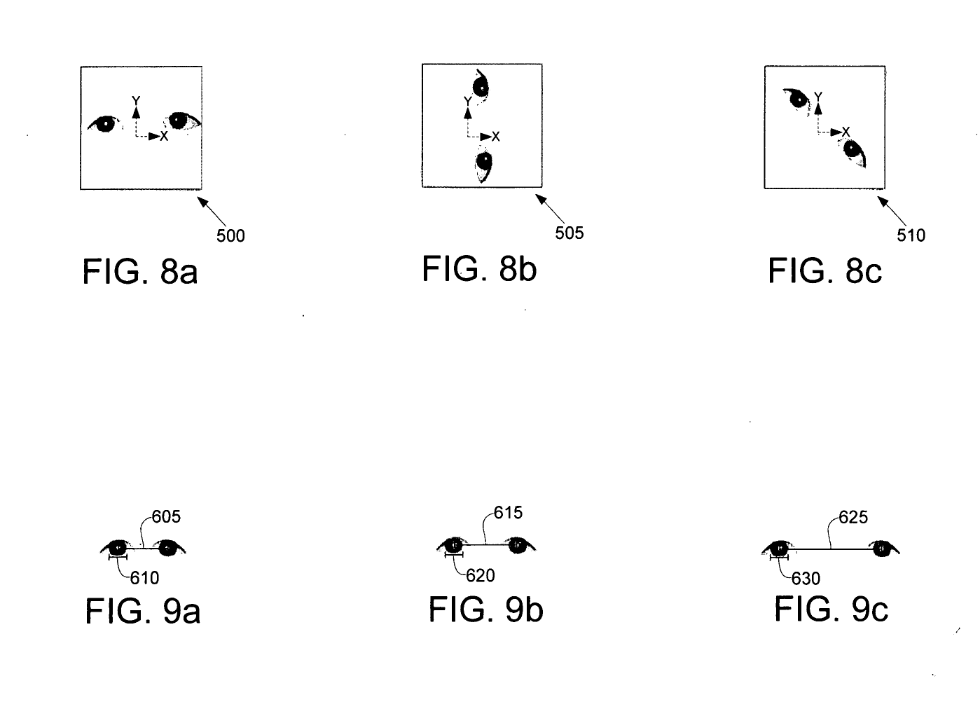

In addition to the comparison of the respective orientation of each eye, the orientation of pairs of eye candidates (angle of eyes) may also be used to determine whether eye candidates likely represent a pair of eyes. This determination presumes that it is more likely for a pair of eyes to be horizontally or vertically disposed in an image than disposed at an angle. FIG. 8A shows an illustrative example of two eyes 500 positioned substantially along a horizontal ‘x’ axis, and FIG. 8B shows an illustrative example of two eyes 505 positioned substantially along a vertical ‘y’ axis. FIG. 8C shows an illustrative example of two eyes 510 positioned along a line disposed at approximately 45 degrees from a vertical ‘y’ axis and a horizontal ‘x’ axis. Because finding a pair of eyes at an angle is unlikely, the pairs of eyes 500, 505 illustrated in FIGS. 8A and 8B represent likely matching eye candidates, whereas the pair of eyes 510 illustrated in FIG. 8C does not represent likely matching eye candidates. As a result, a high score is assigned to eye pairs that are close to vertical or horizontal, while a low score is assigned to pairs that are close to a 45 degree angle. According to one aspect of the invention, a pair of candidate eyes oriented vertically or horizontally may receive a high score, such as 1, while a pair at a 45 degree angle may receive a low score, such as 0. Angles positioned in between vertical or horizontal and 45 degrees may receive a score between 0 and 1, determined by interpolation, as is known in the art. Other techniques may be used, including assigning scores based on threshold values. For instance, pairs of eyes positioned at an angle between 5 and 22 degrees may receive the same score, whereas eyes positioned at an angle between 23 and 40 degrees may receive another score. Additionally, it will be appreciated that the orientation of a pair eyes may be determined using the process described above with respect to FIG. 7.

As shown in FIGS. 9A-9C, the distance between eye candidates, or the ratio of their distance to the size or diameter of one eye in the pair of eye candidates, may be used to assign a score to pairs of eye candidates. It will be appreciated that although the size of a red eye may vary from person to person or based on lighting conditions, there is assumed an acceptable range for the ratio of distance to size or diameter. According to one aspect of the invention, an acceptable ratio of distance to diameter is approximately 3 to 11. If a ratio is found to be outside this range, a pair may receive a low score. Furthermore, interpolation may be used to assign a pair of eyes a score based on the deviation of their ratio from a specified ratio value, such as from 7. FIG. 9A shows an illustrative non-matching pair of eyes located near each other, with a ratio determined by the distance of their separation 605 divided by the diameter 610 of one eye. FIG. 9B shows an illustrative matching pair of eyes having an appropriate ratio determined by the distance of their separation 615 divided by the diameter 620 of one eye. Finally, FIG. 9C shows an illustrative non-matching pair of eyes located far from each other with a ratio determined by the distance of their separation 625 divided by the diameter 630 of one eye. It will be appreciated by those of ordinary skill in the art that the diameter of each candidate eye may be measured from the center of the candidate eye to the center of the candidate eye, or from an edge of one iris to the edge of another iris or the center of a candidate eye. Furthermore, it will be appreciated that the ratio calculation upon which a score is assigned may utilize any measure of eye size, including the diameter of a candidate eye, the radius of a candidate eye, the number of white pixels in each candidate eye, and/or the number of red pixels in each candidate eye.

FIG. 10 shows a flow chart of a red eye pair identification process 700 according to an embodiment of the invention. According to an embodiment of the invention, after the identification of two eye candidates, scores are calculated using each of the methods described above. Scores are calculated based on: a comparison of the number of red eye pixels of each of the candidate eyes at block 705; a comparison of the number of white pixels of each of the candidate eyes at block 710; a comparison of the orientation of the respective candidate eyes at block 715; a determination of the angle of the pair of candidate eyes at block 720; and a determination of the ratio of distance between a pair of candidate eyes to the size (e.g., diameter) of one of the candidate eyes at block 725. It will be appreciated that although five scoring methods are shown, the present invention may be implemented using only one method, or any combination of such methods.

Weights are assigned to each score at blocks 730, 735, 740, 745, and 750, where each score receives a weight value so that scores may reflect the importance and/or accuracy of the methods used to calculate the scores. According to one aspect of the invention, each of the scores are multiplied by their respective weights. As an illustrative example, scores may fall within a range of from 0.1 to 1, and weights may range from 0 to 100. Multiplying the scores by their respective weights, and adding each of the results will determine a weighted score in block 755. Subsequently a normalized score is determined at block 760, where the normalized score is the weighted score divided by the sum of the total weights assigned to the scores. An illustrative example is shown in the table below:

| Type of Calculation | Score | Weight | Score × Weight |
|---|---|---|---|
| Red Pixels | 0.6 | 25 | 15 |
| White Pixels | 0.5 | 17 | 8.5 |
| Orientation of Each Eye | 0.3 | 34 | 10.2 |
| Angle of Eye Candidates | 0.7 | 15 | 10.5 |
| Ratio of Distance to Size | 0.4 | 40 | 16 |
| | | Total weight = | Weighted Score = |
| | | 131 | 60.2 |

Normalized Score = (Weighted Score)/(Total Weight) = 60.2/131 = 0.46

It will be appreciated that any values for score and weight may be used to compare each eye candidate with each other eye candidate to achieve a normalized score. After the normalized score is determined, each of the pairs are ranked based on their normalized score at block 765, so that pairs with high scores, and thus a high likelihood of forming a matching pair of eyes, may be identified. According to one aspect of the invention, the pair of eye candidates with the highest score is presumed to be a matching pair and the process may repeat. According to another aspect of the invention, pairs of eye candidates above a pre-set threshold may be deemed a matching pair.

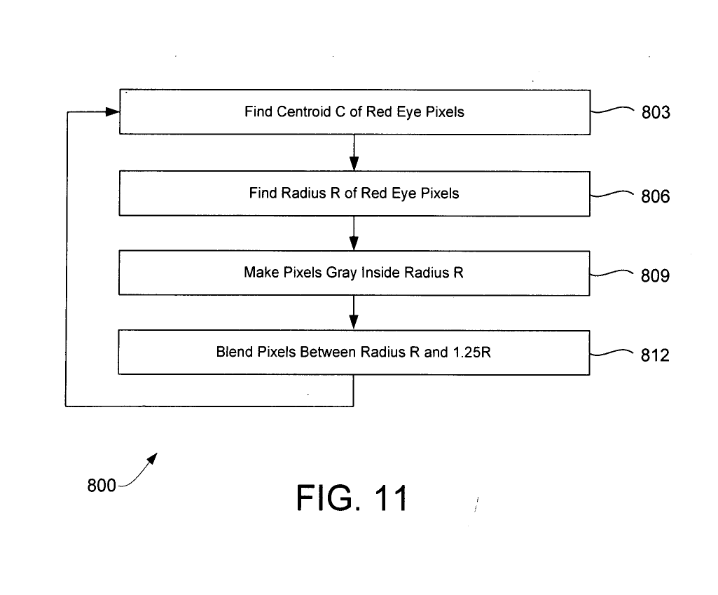

After a red eye has been identified, the red eye effect can be removed. FIG. 11 shows a flow chart of a red eye reduction process 800 according to an embodiment of the present invention. Specifically, once a red eye region has been located, such as by a mapping scheme 250, as described above, the red eye reduction process 800 can calculate a centroid of the red eye pixels as a center of the red eye at block 803. A radius of the red eye can be calculated from the number of red eye pixels found in the region at block 806. For example, if the number of red eye pixels is N, the radius R is given by: R=square root of (N/π), where, π=3.14159. The color of pixels inside the radius R can be converted to another color, such as gray at block 809. Red eye effect correction can be made for the identified region using any coloring technique at block 812 for pixels outside the radius and an extended radius, if desired. FIG. 3O shows a finished image 186 with the red eye effect removed from the original image 160 (FIG. 3A).

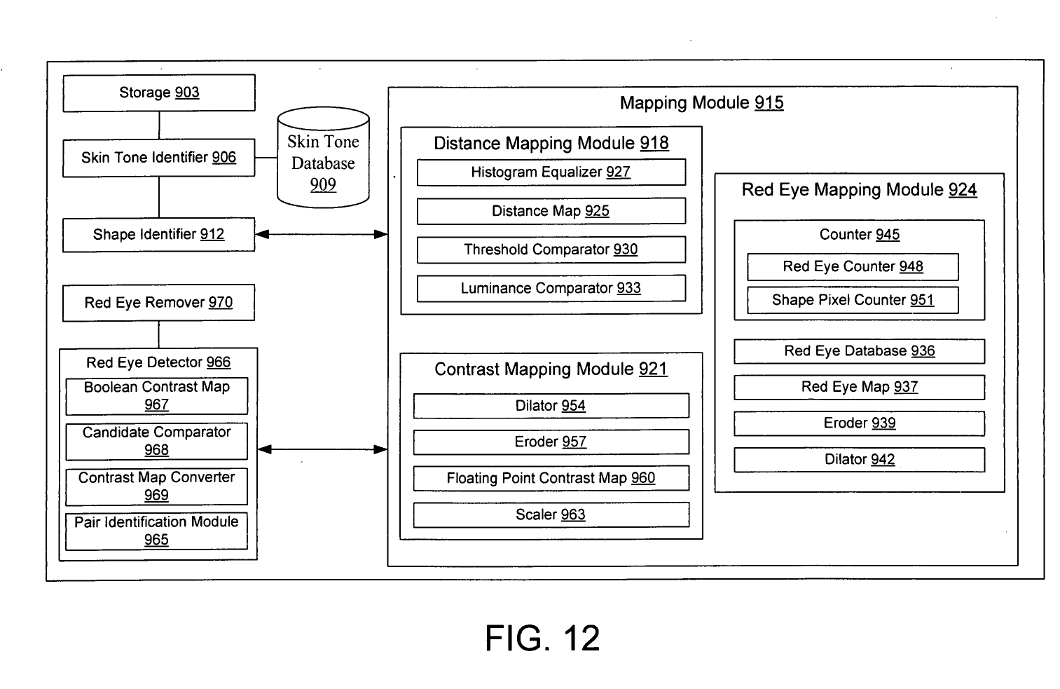

FIG. 12 shows a red eye reduction system 900 according to an embodiment of the present invention. The red eye reduction system 900 can include an image storage component 903 such as a memory, a disk, a buffer, and the like, that stores image data of an image. A skin tone identifier 906 can retrieve the image data from the connected image storage component 903 to identify image data having characteristics of skin pixels. For example, as described earlier, the image data can be compared with data in a skin tone database 909. Although the storage component 903 and the skin tone database 909 are shown to be individual components, they can instead be part of a larger memory structure. Once pixels having characteristics of skin tone have been detected, a shape identifier 912 can be used to identify from the detected skin tone pixels an appropriate candidate shape, or a candidate face for further analysis. The shape identifier 912 can identify a shape that can include a red eye as described above with reference to FIG. 4. Once the shape has been identified, pixels of the identified shape can be fed to a mapping module 915.

In general, the mapping module 915 can map image attributes of the identified pixels to identify some facial components or features, such as an eye, a white portion of an eye, an iris of an eye, wrinkles, a nose, a pimple, a mouth, teeth in a mouth, and the like. The mapping module 915 can include a distance mapping module 918, a contrast mapping module 921, and/or a red eye mapping module 924. The distance mapping module 918 can be configured to find a white portion of an eye. For example, for each shape, face box or other region identified, the distance mapping module 918 can generate a distance map 925. In the distance map 925, the distance mapping module 918 can store a color space distance from a neutral color for each pixel. For example, if a pixel has a high luminance value and is relatively close to a neutral color, the image data or the corresponding pixel can be considered white. In some embodiments, the color distance is determined by calculating the standard deviation between red, green and blue components of the pixel. Since distances found using the distance mapping module 918 can fall within a relatively narrow band, and can be generally difficult to distinguish from one another, a histogram equalizer 927 can be used to equalize or normalize the distances stored in the distance map 925. Equalized or normalized distances can then be compared to a threshold comparator 930 with a predetermined high threshold. Thus, the distance map 925 can be transformed to a Boolean distance map carrying true or false values. For example, any pixel having a distance above a particular value can be considered white and made true in the Boolean distance map, while other pixels having distances less than the value can be labeled false. Comparing the luminance values of the pixels in a luminance comparator 933 can further reduce the distance map. For example, if the luminance of a pixel is less than a threshold value, the luminance comparator 933 can label the pixel as being not white. The corresponding distance in the distance map 925 can therefore be removed.

The red eye mapping module 924 can include a red eye database 936 which can be generated as described earlier. At run time, for each pixel in face box or other region, the red eye mapping module 924 can determine whether the pixel is a red eye pixel. In some embodiments, true or false results are stored in a red eye map 937. A few iterations or passes of erosion followed by dilation can also be performed on the red eye map 937 with an eroder 939 and a dilator 942. The process of erosion followed by dilation can be used to open up small gaps between touching regions or groups. Thus, the red eye mapping module 924 can find connected regions, and/or can decide whether the connected regions belong to a red eye, such as by using a counter 945. The counter 945 can include a shape pixel counter 951 and/or a red eye pixel counter 948, which output a number pixels in the candidate face shape and a number of red eye pixels found in the shape, respectively. Unlikely candidates can be deleted from the red eye map 937 when the number of connected red eye pixels is greater than a pre-determined threshold, for example.

The contrast mapping module 921 can include a gray scale dilator 954 and a gray scale eroder 957 to construct a floating point contrast map 960 of the facial area created or generated previously (e.g., by a in shape identifier 912). Since values in the contrast map 960 can vary from face to face, the values can be scaled by a scaler 963, such as between 0 and 255 for each face. Optionally, pixels can be skipped to speed up the mapping process.

The red eye reduction system 900 can also include a red eye detector 966 coupled to the mapping module 915. The red eye detector 966 can use the maps 925, 937, 960 generated in the mapping module 915 to determine if a red eye is present. By way of example only, the red eye detector 966 can start by making a Boolean contrast map 967 from the floating-point contrast map 960 in a contrast map converter 969. If a floating point contrast entry in the floating point contrast map 960 is greater than a predetermined threshold, a corresponding entry in the Boolean contrast map 967 can be labeled true. Otherwise, the entry can be labeled false in the Boolean contrast map 967. In some embodiments, the red eye reduction system 900 can then find if connected regions are present in the Boolean contrast map 967. When the red eye reduction system 900 has located connected regions, sizes and shapes of the connected regions can be determined. Based at least in part on the shape and the size of the connected regions found, the red eye reduction system 900 can determine if the connected regions are a red eye candidate at a candidate comparator 968. Unlikely candidates can be deleted.

In some embodiments, for each candidate region, the red eye reduction system 900 looks at the red eye map 937 and the distance map 925. If a candidacy comparator 968 determines a pixel value is the same in both the red eye map 937 and the distance map 925, the connected region can be considered a red eye. If the red eye reduction system 900 finds two eyes for a face, the red eye reduction system 900 can stop automatically. Otherwise, the red eye reduction system 900 can re-scale the floating-point contrast map 960 and repeat the above-described process, making another Boolean contrast map. The pair identification module 965 may implement the processes described above with reference to FIGS. 6a-10 to identify those red eyes that likely form a matching pair of red eyes. After a red eye, or according to an embodiment of the invention, matching red eye pairs, are identified, a red eye remover 970 can automatically remove the red eye effect from the image.

Various features and advantages of the invention are set forth in the following claims.

1. A method of identifying a pair of eyes, comprising:
identifying a first eye candidate and a second eye candidate in a digital image;
determining at least one attribute associated with the first eye candidate, and at least one attribute associated with the second eye candidate; and
comparing the at least one attribute associated with the first eye candidate to the at least one attribute associated with the second eye candidate to determine whether the first eye candidate and the second eye candidate form a matching pair of eyes.

2. The method of claim 1, wherein the at least one attribute associated with the first eye is the number of substantially red eye pixels of the first eye, and wherein the at least one attribute associated with the second eye is the number of substantially red eye pixels of the second eye.

3. The method of claim 2, wherein the at least one attribute associated with the first eye is a measure of the size of the first eye, and wherein the at least one attribute associated with the second eye is a measure of the size of the second eye.

4. The method of claim 1, wherein the at least one attribute associated with the first eye is the number of substantially white pixels of the first eye, and wherein the at least one attribute associated with the second eye is the number of substantially white pixels of the second eye.

5. The method of claim 1, further comprising determining the orientation of the first eye based on the location of white pixels in a region surrounding the first eye and determining the orientation of the second eye based on the location of white pixels in a region surrounding the second eye.

6. The method of claim 1, wherein the at least one attribute associated with the first eye is the orientation of the first eye, and wherein the at least one attribute associated with the second eye is the orientation of the second eye.

7. The method of claim 1, further comprising ranking the first eye candidate and the second eye candidate in a plurality of eye-pairs.

8. The method of claim 1, further comprising:
assigning a score, based on the comparison of the at least one attribute associated with the first eye candidate and the at least one attribute associated with the second eye candidate; and
determining whether the first eye candidate and the second eye candidate form a matching pair of eyes based on the score.

9. A method of identifying a pair of eyes, comprising:
identifying a first eye candidate and a second eye candidate in a digital image;
determining the size of the first eye candidate;
determining the distance between the first eye candidate and the second eye candidate;
calculating a ratio based on the distance and the size of the first candidate;
assigning a score, based on the calculation of the ratio, wherein the score is indicative of whether the first eye candidate and the second eye candidate form a matching pair of eyes.

10. The method of claim 9, wherein the size of the first eye candidate comprises the radius of the iris of the first eye candidate.

11. The method of claim 9, wherein the size of the first eye candidate comprises the circumference of the iris of the first eye candidate.

12. The method of claim 9, wherein determining the size of the first eye candidate comprises determining the size of the first eye candidate based on a measure of the amount of substantially white pixels in the first eye candidate.

13. The method of claim 9, wherein determining the size of the first eye candidate comprises determining the size of the first eye candidate based on a measure of the amount of substantially red pixels in the first eye candidate.

14. The method of claim 9, wherein determining the distance between the first eye candidate and the second eye candidate comprises determining the distance between substantially the center of the first eye candidate and substantially the center of the second eye candidate.

15. The method of claim 9, further comprising ranking the first eye candidate and the second eye candidate in a plurality of eye-pairs based on the score.

16. A method of identifying a pair of eyes, comprising:
identifying a first eye candidate and a second eye candidate in a digital image;
determining an average eye size of the first eye candidate and the second eye candidate;
determining the distance between the first eye candidate and the second eye candidate;
calculating a ratio based on the distance and the average eye size; and
identifying, based on the calculated ratio, that the first eye candidate and the second eye candidate form a matching pair of eyes.

17. A method of identifying a pair of eyes, comprising:
identifying a plurality of eye candidates in a digital image;
determining an attribute associated with each one of the plurality of eye candidates;
comparing the attribute of a first eye candidate of the plurality of eye candidates to the attribute of each other eye candidate of the plurality of eye candidates;
assigning respective scores, based on the comparison, of the first eye candidate and each of the other eye candidates of the plurality of eye candidates; and
identifying at least one matching pair of eyes based on the respective scores.

18. The method of claim 17, wherein determining an attribute comprises measuring the number of substantially white or substantially red pixels associated with each one of the plurality of eye candidates.

19. The method of claim 17, wherein determining an attribute comprises determining the orientation of each one of the plurality of eye candidates.

20. The method of claim 17, wherein determining an attribute comprises determining the size of each one of the plurality of eye candidates.

21. The method of claim 20, wherein comparing the attribute comprises determining the distance between the first eye candidate and each other eye candidate.

22. The method of claim 17, wherein determining an attribute comprises the ratio of substantially white pixels to substantially red pixels in each one of the plurality of eye candidates.
